(19) United States
(12) Patent Application Publication
(10) Pub. No.: US 2009/0279914 A1
(43) Pub. Date: Nov. 12, 2009

(54) IMAGE FORMING APPARATUS

(75) Inventor: Takahiro Iwasaki, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/437,325

(22) Filed: May 7, 2009

(30) Foreign Application Priority Data
May 12, 2008 (JP) 2008-124526

(51) Int. Cl. G03G 21/00

(52) U.S. Cl. 399/71

(57) ABSTRACT

An image forming apparatus has a cleaning blade in contact with at least one of a first rotation body and a second rotation body which rotate in contact with each other, so as to clean a circumferential surface of the rotation body, and a control section to control the first drive device or the second drive device when a countable value of countable control items memorized in the control section reaches to a predetermined value by changing a linear speed difference between the first rotation body and the second rotation body so that a load torque of the rotation body to which the cleaning blade contacts falls within a load torque range in which control for rotation angular speed of a drive motor is possible.

This application is based on Japanese Patent Application No. 2008-124526 filed on May 12, 2008, in Japanese Patent Office, the entire content of which is hereby incorporated by reference.

### TECHNICAL FIELD

The present invention relates to an image forming apparatus using an electrophotographic method.

### BACKGROUND

In the image forming apparatus of the electrophotographic method, it is common that a latent image is formed on a photoconductive body by scanning exposure with a laser beam, the formed latent image is developed by a developing device and an image of toner is formed on the photoconductive body.

The image of the toner formed on the photoconductive body is transferred directly on a sheet by a transfer device or via an intermediate transfer body.

In a number of color image forming apparatuses are configured such that a first transfer device transfers an image visualized on the photoconductive body onto the intermediate transfer body, and a second transfer device transfers the image transferred on the intermediated transferred body onto a sheet.

The photoconductive body and the intermediate transfer body are rotating bodies in a shape of a drum or a belt which rotate in contact with each other at a predetermined position.

Linear speeds of the photoconductive body and the intermediate transfer body rotating in contact with each other are not the same, and there is provided a difference in the linear speeds so as to improve transfer efficiency of the toner image onto the intermediate transfer body (for example, Patent Documents 1 and 2: unexamined Japanese patent application publication No. 2001-201902 and 2001-201912).

On a circumferential surface of the rotating body, since residual toner is left without being transferred and a dust exist, there is provided a cleaning section to remove them form the circumferential surface of the rotation body.

The cleaning section is provided with a blade in slide contact with the circumferential surface of the rotation body. The blade is disposed in the way that an end of the blade thereof directs an opposite direction to a moving direction of the circumferential surface of the rotating body.

Therefore, the blade so-called a cleaning blade creates a large load for a drive device to rotate the rotating body.

The first rotating body representing the photoconductive body and the second rotating body representing the intermediate transfer body are rotated by a first drive device to drive the first rotating body and a second drive device to drive the second rotating body respectively so as to maintain predetermined speeds respectively determined.

The cleaning section having the cleaning blade can be disposed at both the first and the second rotation bodies or can be disposed at only one of the rotation bodies thereof.

In a number of the first drive devices to drive the first rotating body and the second drive devices to drive the second rotating body are controlled by brush less direct current motors and encoders so that the rotating bodies maintain the predetermined linear speeds.

However, as a process amount of the image forming apparatus increases, the circumferential surface of the rotating body is abraded by a friction of the blade, and the toner starts to adhere little by little on the circumferential surface of the rotation body on which toner does not adhere at an initial stage of use after the image forming apparatus is delivered.

Such wearing of circumferential surface of the rotating body and a small amount of the residual toner on the circumferential surface of the rotating body reduce a load generated by sliding of the blade and the rotating body.

When the reduction of the load progresses to a certain level, control of the drive device to maintain the linear speed of the rotating body at a predetermined speed becomes difficult and a fluctuation of rotation occurs, then as the result, a trouble such as color drift may occur.

Patent document 1: Unexamined Japanese patent application publication No. 2001-201902

Patent document 2: Unexamined Japanese patent application publication No. 2001-201912

The present invention has one aspect to solve the above problems and an object of the present invention is to provide an image forming apparatus provided with a cleaning blade to clean a circumferential surface of the rotating body by contacting at least one of two rotating body, wherein an occurrence of a fluctuation of rotation is suppressed by changing a linear speed difference between the two rotation bodies, when a countable value of a countable control item reaches a predetermined value.

### SUMMARY

To achieve the above object, the image forming apparatus reflecting one aspect of the present invention includes: a first rotation body and a second rotation body to rotate in contact with each other; a cleaning blade to clean a circumferential surface of the rotation body in contact with at least one of the first rotation body and the second rotation body; a first drive device to rotate the first rotation body; a second drive device to rotate the second rotation body; and a control section to control the first drive device or the second drive device by changing a linear speed difference between the first rotation body and the second rotation body when a countable value of a countable control item memorized in the control section reaches to a predetermined value so that a load of the rotation body in contact with the cleaning blade falls within a load torque range in which control for rotation angular speed of a drive motor is possible.

### BRIEF DESCRIPTION OF THE DRAWINGS

FIG. 1 is a schematic diagram of an image forming apparatus.

FIG. 2 is a block diagram showing control of the image forming apparatus.

FIG. 3 is a diagram describing arrangement of rotating bodies and linear speeds.

FIG. 4 is a block diagram describing a first drive device and a second drive device.

FIG. 5 is a flow chart showing a flow of a linear speed difference control process of the first rotating body and the second rotating body.

FIG. 6 is a chart describing an example of the linear speed difference control.

FIG. 7 is a diagram showing an example in which the second rotating body is a sheet conveyance belt.

### DETAILED DESCRIPTION OF PREFERRED EMBODIMENTS

An exemplary embodiment of the present invention will be described with reference to the drawings. Meanwhile, the present invention is not limited to the embodiment thereof.

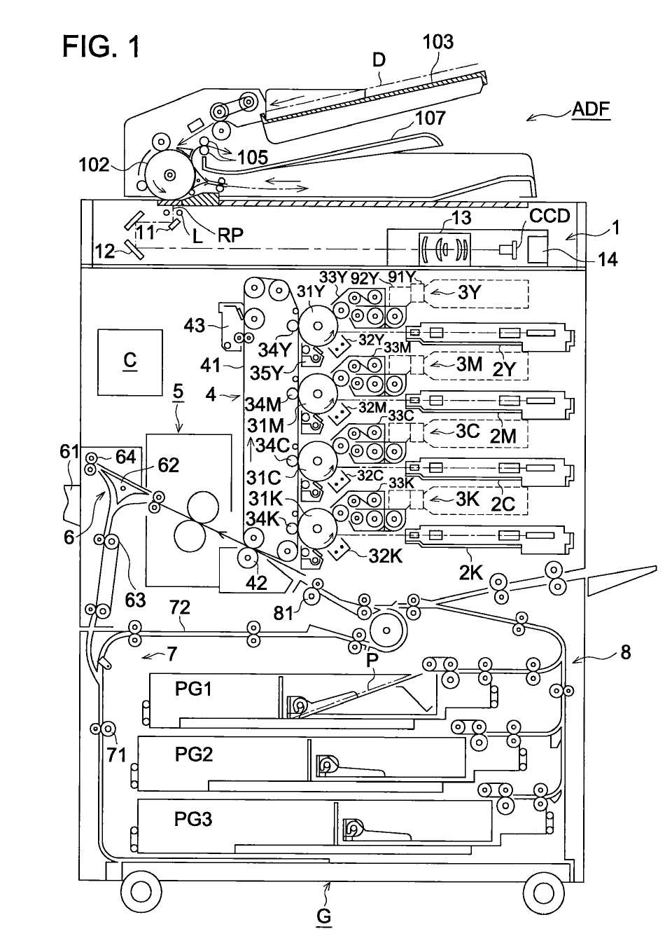

FIG. 1 is a schematic diagram of an image forming apparatus G.

The color image forming apparatus G exemplified in the figure is so-called a tandem type color image forming apparatus to form a full color image in which a plurality of photoconductive bodies 31Y, 31M, 31C and 31K are disposed in a vertical array so as to face an intermediate transfer belt 41.

The color image forming apparatus G is provide with an automatic draft feeding apparatus ADF on an upper part thereof.

A draft D placed on the draft placing table 103 of the automatic draft feeding apparatus ADF is separated and sent out piece by piece to a draft conveyance path and conveyed through a conveyance drum 102.

An image of the draft D during conveyance is read by a draft reading section 1 at a draft image reading position RP. The draft D having been read is ejected to a draft ejection table 107.

The image forming apparatus G is configured with the draft reading section 1; exposing sections 2Y, 2M, 2C and 2 K; image forming sections 3Y, 3M, 3C, and 3K; an intermediate transfer section 4; a fixing section 5; an ejection sheet reversal section 6; a sheet re-feeding section 7; a sheet feeding section 8; a control section C and so forth which are incorporated in a housing.

In the draft reading section 1, an image on a draft is irradiated by a lamp L at the draft reading position RP, the reflected light is lead through a first mirror unit 11, a second mirror unit 12 and a lens 13, and forms an image on a light receiving surface of an imaging element CCD.

An image signal via photo-electro conversion by imaging element CCD is subject to A/D conversion, shading correction and compression in the image reading control section 14, and stored in a memory of the control section C as image data.

The image data stored in the memory is subject to appropriate image processes in accordance with a condition set by a user so as to produce output image data.

The exposure sections 2Y, 2M, 2C and 2K are configured with laser light sources, polygon mirrors, a plurality of lenses so as to produce laser beams.

The exposing sections 2Y, 2M, 2C and 2K performs scan exposure on a surface of the photoconductive bodies 31Y, 31M, 31C and 31K representing components of the image forming sections 3Y, 3M, 3C and 3K by a laser beam in accordance with output information outputted based on the output image data sent from the control section C.

A latent image is formed on the photoconductive bodies 31Y, 31M, 31C and 31K by scanning exposure with the laser beams.

The image forming section 3Y is configured with the photoconductive body 31Y and other sections disposed at a periphery thereof, i.e. a main charging section 32Y, developing section 33Y, a first transfer roller 34Y and a cleaning section 35Y. The photoconductive bodies 31M, 31C and 31K are configured in the same manner.

The latent images on the photoconductive bodies 31Y, 31M 331C and 31K are visualized by developing with the corresponding developing section 33Y, 33M, 33C and 33K and a toner image is formed on each photoconductive body.

The toner images formed on the photoconductive bodies 31Y, 31M, 31C and 31K are transferred successively at a predetermined position on the intermediate transfer belt 41 representing the intermediate transfer body by the first rollers 34Y, 34M, 34c and 34K of the intermediate transfer device 4.

By the cleaning sections 35Y, 35 M, 35C and 35K, residual toner is removed from the surfaces of the photoconductive bodies where the toner images have been transferred.

On the other hand, the toner images transferred onto the intermediate transfer belt 41 is transferred onto a sheet P conveyed from tray PG1, PG2 or PG 3 of the sheet feeding section 8 or a sheet feeding apparatus S1 by the second transfer roller 42 and sent out with a proper timing by a sheet feeding roller 81.

The surface of the intermediate transfer belt 41 from which the toner images have been transferred onto the sheep P, is cleaned by the belt cleaning section 43 to be served for subsequent image transfer.

On the other hand, the sheet P carrying the toner image is sent to the fixing section 5 so that the toner image is fixed onto the sheet P by heat and pressure.

The sheet P having been fixed by the fixing section 5 is conveyed through the ejection sheet reversal section 6, and ejected onto the sheet ejection table 61. In case the sheet P is ejected reversely upside down, the sheet P is led downward once by the ejection sheet guide 62 and an ejection sheet reversal roller 63 grasps an end of the sheet P, thereafter, by rotating the roller 63 in a reverse direction, the sheet P is led to ejection rollers 64 by the sheet ejection guide 62 to be ejected.

Meanwhile, in case image forming is carried out for a reverse side of the sheet P, the sheet P having a fixed image on an obverse surface thereof is conveyed to a sheet re-feeding section 7 located on a lower side.

After the rear end is grasped by re-feeding sheet reversal rollers 71, the sheet P is sent in an opposite direction to be reversed and sent out to a re-feeding sheet conveyance path 72 to be served for image forming on the reverse side.

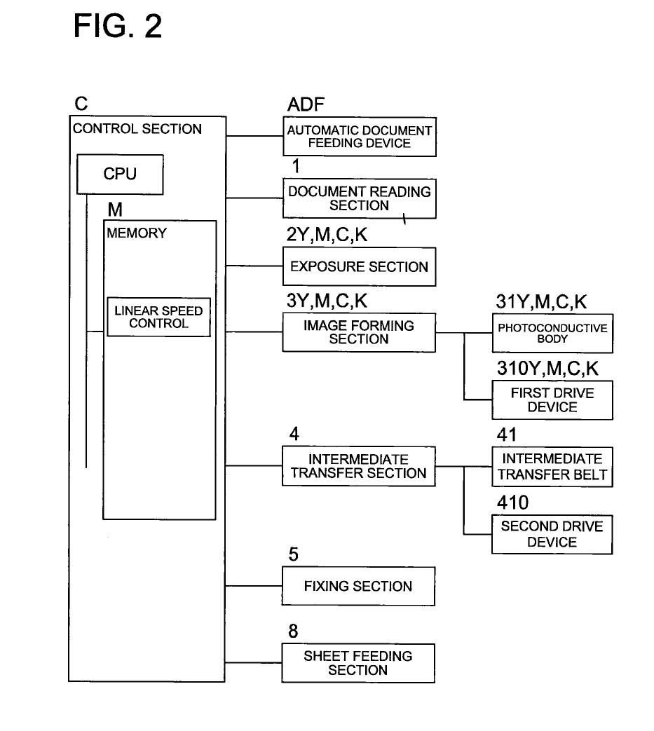

FIG. 2 is a block diagram showing control of the image forming apparatus G.

The control section C of the image forming apparatus G is a computer system having a CPU, a memory, a calculation unit, an I/O port, a communication interface, a drive circuitry and so forth.

Control by the control section C is executed by executing a predetermined program stored in a memory M. Also, the control section C is connected via a net work with other information processing equipment so as to exchange information.

Meanwhile, in FIG. 2, descriptions of blocks not directly related to explanation of the present invention are omitted.

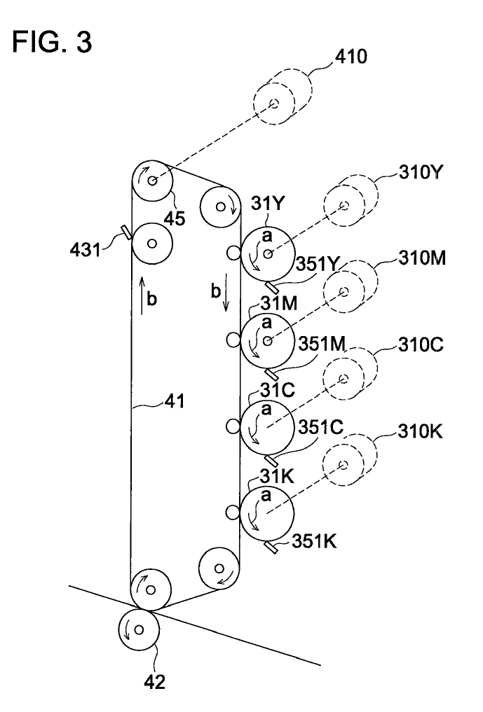

FIG. 3 is a diagram describing an arrangement of the rotation bodies and the linear speed.

The first rotation bodies in FIG. 3 are the photoconductive bodies 31Y, 31M, 31C and 31K in the shape of a drum, and the second rotation body is an intermediate transfer belt 41 representing an intermediate transfer body in a shape of a belt. The cleaning blades 351Y, 351M, 351C and 351K of the cleaning sections 35Y, 35M, 35C and 35K (shown in FIG. 1) are in contact with the photoconductive bodies 31Y, 31M, 31C and 31K.

The photoconductive bodies 31Y, 31M, 31C and 31K representing the first rotation bodies are driven by first drive devices 310Y, 310M, 310C and 310K schematically shown by broken lines in the figure.

Also, the intermediate transfer belt 41 representing the second rotation body is installed on a plurality of rollers, and a cleaning blade 431 of the belt cleaning section 43 (shown in FIG. 1) is in contact with the intermediate transfer belt 41. The intermediate transfer belt 41 is rotated by the second drive device 410 to drive and rotate the drive roller 45.

The first drive 310Y, 310M, 310C and 310K and the second drive device 410 are controlled so as to maintain a predetermined rotation speed by control signals for the first drive devices 310Y, 310M, 310C and 310K, and the second drive device 410 sent from the control section C.

Between a linear speed S1 at circumferential surfaces of the photoconductive bodies 31Y, 31M, 31C, and 31K rotating in a direction a in the figure, and a linear speed S2 of the intermediate transfer belt 41 rotating in a direction b in the figure, there is provided a speed difference so that the linear speed S2 is slightly faster than the linear speed S1.

The above setting enhances transfer efficiency of the toner image onto the intermediate transfer body for a purpose of ensuring transfer of the image.

Therefore, since the intermediate transfer belt 41 is in contact with the photoconductive bodies 31Y, 31M, 31C and 31K, forces towards the rotation direction are applied on the circumferential surfaces of the photoconductive bodies 31Y, 31M, 31C and 31K.

As far as the linear speed S1 on the circumferential surfaces of the photoconductive bodied 31Y, 31M, 31C and 31K, and the linear speed S2 of the intermediate transfer belt 41 are maintained at constant values, the difference of the linear speeds S3=S2−S1 is maintained constantly.

To the circumferential surfaces of the photoconductive bodied 31Y, 31M, 31C and 31K, cleaning blades 351Y, 351M, 351C and 351K to remove residual transferred toner remaining after image transfer are in contact so that the circumferential surfaces rotate in a sliding manner with the cleaning blades 351Y, 351M, 351C and 351K.

Therefore, the circumferential surfaces of the photoconductive bodies 31Y, 31M, 31C and 31K, rotating in the sliding manner with the cleaning blades 351Y, 351M, 351C and 351K, is gradually abraded. Also, minimal excrescences such as toner can be accumulated on the circumferential surfaces.

As the result, a friction resistance between the photoconductive bodies 31Y, 31M, 31C and 31K, and the cleaning blades 351Y, 351M, 351C and 351K changes to be reduced.

As described above, with the change of circumferential surfaces of the photoconductive bodies 31Y, 31M, 31C and 31K, loads of the first drive devices 310Y, 310M, 310C and 310K to rotate and drive the photoconductive bodies 31Y, 31M, 31C and 31K representing the first rotation bodies change to be reduced.

With the above reductions of the loads, when a drive load torque departs from a range of the drive load torque in which control for the first drive devices 310Y, 310M, 310C and 310K to maintain a rotation angular speed to be constant is possible, and falls below a lower limit value, rotation becomes unsteady and a rotation fluctuation occurs.

As described in forgoing, on the circumferential surface of the photoconductive bodies 31Y, 31M, 31C and 31K, since a fractional force towards the rotation direction is applied by the intermediate transfer belt 41, there is occurred a phenomenon that the circumferential surfaces of the photoconductive bodies 31Y, 31M, 31C and 31K is dragged irregularly towards the rotation direction.

The above fluctuation of rotation appears on the image as color shift which deteriorates image quality to a large extent.

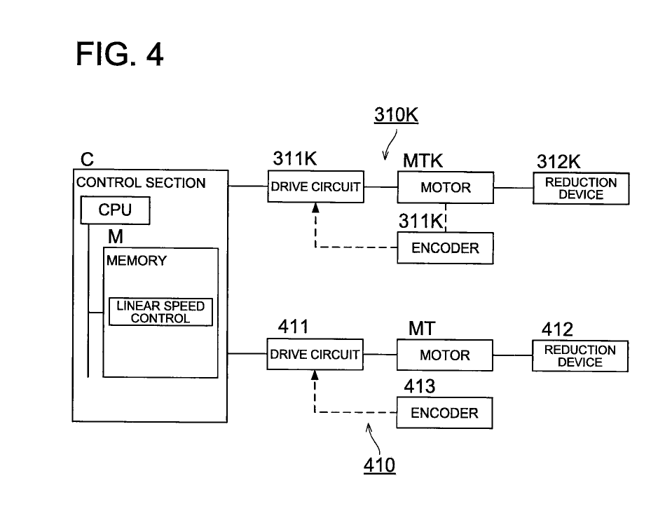

FIG. 4 is a block diagram describing the first drive device 310K and the second drive device 410.

Since the first drive devices 310Y, 310M, 310C and 310K are configured in the same manner for each color, only the first drive device 310K is shown in the figure.

The first drive device 310K is configured with a drive circuitry 311, a motor MTK, a speed reducer 312K and an encoder 313K.

The drive circuitry 311K drives the motor MTK so as to maintain a designated rotation speed based on a control signal sent from the control section C.

Number of rotation of the motor MTK per unit time is counted by the encoder 313 to be fed back to the drive circuitry 311K, and control to maintain the designated rotation speed is carried out.

Rotation of the motor MTK is propagated to the photoconductive body 31K representing the first rotation body via the speed reducer 312. The photoconductive body 31K rotates at a predetermined linear speed S1.

The second drive device 410 also has the same configuration as above. The number of rotation of the motor MT per unit time is counted by the encoder 413 and fed back to the drive circuitry 411 so that control to maintain a designated rotation speed is carried out.

Rotation of the motor MT is propagated to the drive roller 45 via the speed reducer 412 and the intermediate transfer belt 41 rotates at a predetermined linear speed S2.

The present invention is to prevent occurrence of a problem caused by a load fluctuation of the first rotation body as described with reference to FIG. 3, by changing the speed difference S3 between the speed of the intermediate transfer belt 41 initially set and the speed of the circumferential surfaces of the photoconductive bodies 31Y, 31M, 31C and 31K, in accordance with the countable value of the countable control items designated in advance.

As the countable control items, items related to the load fluctuation of the first drive devices 310Y, 310M, 310C and 310K caused by change of circumferential surfaces of the photoconductive bodies 31Y, 31M, 31C and 31K as described above are designated.

For such control items, a sliding distance in which the photoconductive bodies 31Y, 31M, 31C and 31K slide with the cleaning blades 351Y, 351M, 351C and 351K, to be proportional to an amount of wearing of the circumferential surfaces of the photoconductive bodies 31Y, 31M, 31C and 31K, number of prints outputted from the image forming apparatus G, and image forming operation time of the image forming apparatus G are appropriate.

Meanwhile, the sliding distance can be obtained from a circumferential length of the photoconductive bodies 31Y, 31M, 31C and 31K and the number of rotation, and since the circumferential length is a constant value, the sliding length can be represented by the number of rotation.

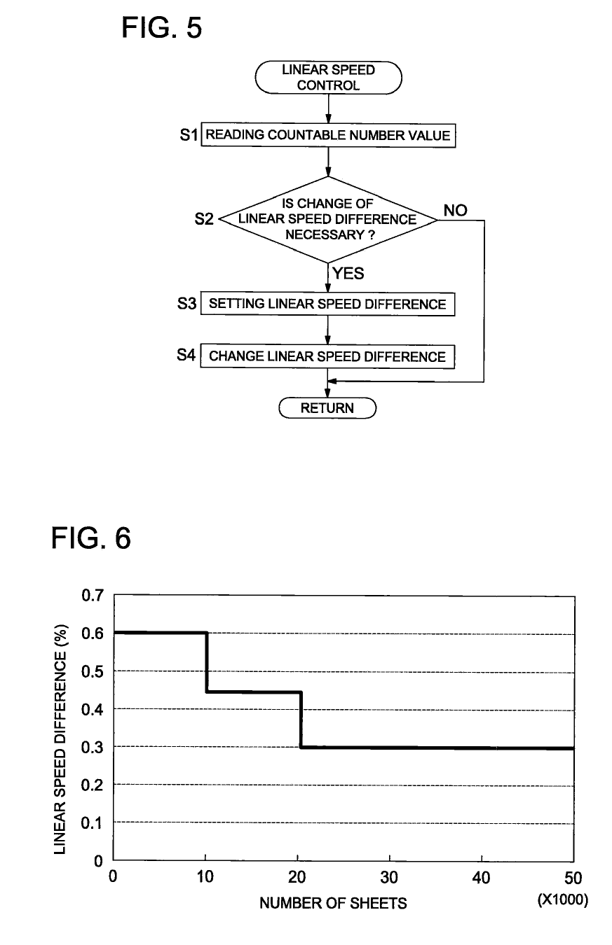

FIG. 5 is a flow chart showing a flow of a linear speed control process of the first and the second rotation bodies.

First, a predetermined countable value of a control item, for example, the number of the prints outputted from the image forming apparatus G is read (Step 1).

Whether or not the countable the value read out exceeds a predetermined value is judged (Step 2), and if it does not exceed (Step 2: No), the flow gets out from a process routine. Or if it exceeds (Step 2: Yes), a linear speed S3 corresponding to the countable the value memorized in a table in advance is read out and set in a predetermined memory area (Step 3).

A drive device control program stored in the control section C sends a control signal to change the number of rotation of motors to rotate the rotation bodies, for example, the motors MTY, MTM, MTC and MTK to rotate the photoconductive bodies 31Y, 31M, 31C and 31K representing the first rotation bodies to the first drive devices 310Y, 310M, 310C and 310K based on a speed difference S3 set in a predetermined memory area.

By the control signal, the linear speed S1 of the first rotation body is changed (Step 4), and the process routine is terminated.

The above example is to change the linear speed difference S3 by changing the linear speed S1 of the first rotation body, however, the change of the linear speed difference S3 can be conducted by changing the linear speed S2 of the second rotation body. Also, the linear speed difference S3 can be change by changing both the linear speed S2 and the linear speed S3.

FIG. 6 is a chart describing an example of linear speed control.

A vertical axis of the chart represents a linear speed difference between the photoconductive bodies 31Y, 31M, 31C and 31K representing the first rotation bodies and the intermediate transfer belt 41 representing the second rotation body. A horizontal axis represents the number of the prints outputted from the image forming apparatus which is the countable control item.

The chart shows an example in which the linear speed of the photoconductive bodies 31Y, 31M, 31C and 31K was changed so that the speed difference between the photoconductive bodies 31Y, 31M, 31C and 31K and the intermediate transfer belt 41 reduces. Meanwhile, the change can be carried out manually or automatically.

By the above change, a force in a direction to reduce the loads of the drive devices 310Y, 310M, 310C and 310K created by the intermediate transfer belt 41 which rotates at a linear speed slightly faster that that of the photoconductive bodies 31Y, 31M, 31C and 31K is reduced.

As the result, the loads applied to the first drive devices 310Y, 310M, 310C and 310K can fall within a certain range in which the first drive device can rotate the photoconductive bodies 31Y, 31M, 31C and 31K representing the first rotation bodies constantly, whereby color shading is avoided.

While the above description has been carried out based on the color image forming apparatus having the intermediate transfer belt, the present invention is effective for a configuration in which two rotation bodies are rotating in contact to each other at different linear speeds respectively.

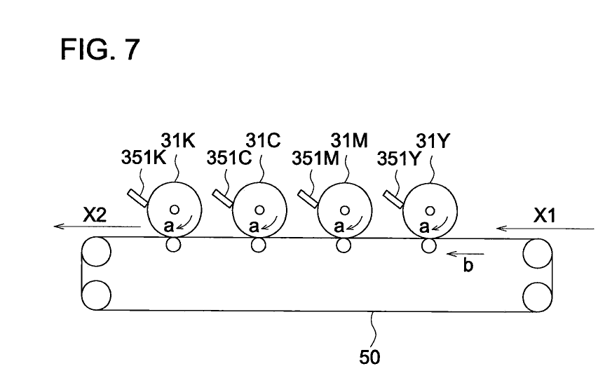

FIG. 7 shows an example wherein the second rotation body is a sheet conveyance belt.

The photoconductive bodies 31Y, 31M, 31C and 31K representing the first rotation bodies and the sheet conveyance belt 50 representing the second rotation body are in contact as the figure shows and rotating at a linear speed a and a linear speed b respectively.

A sheet conveyed form an arrow direction x1 proceeds between the photoconductive bodies 31Y, 31M, 31C and 31K, and the sheet conveyance belt 50 so that a toner images on the photoconductive bodies 31Y, 31M, 31C and 31K are transferred thereon and proceeds in an arrow x2 direction.

As above, according to the present invention, in an image forming apparatus having a cleaning blade to clean a circumferential surface of a rotation body in contact with at least one of two rotation bodies, a fluctuation of rotation of the rotation body generated in accordance with an increase of a process amount is suppressed and a problem such as color shading is avoided.

What is claimed is:

1. An image forming apparatus, comprising:
a first rotation body and a second rotation body to rotate in contact with each other;
a cleaning blade to clean a circumferential surface of the rotation body in contact with at least one of the first rotation body and the second rotation body;
a first drive device to rotate the first rotation body;
a second drive device to rotate the second rotation body; and
a control section to control the first drive device or the second drive device by changing a linear speed difference between the first rotation body and the second rotation body when a countable value of a countable control item memorized in the control section reaches to a predetermined value so that a load of the rotation body in contact with the cleaning blade falls within a load torque range in which control for rotation angular speed of a drive motor is possible.

2. The image forming apparatus of claim 1, wherein the control item is number of prints outputted from the image forming apparatus.

3. The image forming apparatus of claim 1, wherein the control item is a sliding distance of the cleaning blade.

4. The image forming apparatus of claim 1, wherein the control item is image forming operational time of the image forming apparatus.

5. The image forming apparatus of claim 1, wherein the rotation body to which the cleaning blade contacts is an image carrier in a shape of a drum.

6. The image forming apparatus of claim 1, wherein at least one of the first rotation body and the second rotation body is an intermediate transfer belt to which an image visualized by toner development is transferred.

7. The image forming apparatus of claim 1, wherein at least one of the first rotation body and the second rotation body is a sheet conveyance belt to convey a sheet to which an image visualized by toner development is transferred.
